(19) United States
(12) Patent Application Publication
(10) Pub. No.: US 2015/0325214 A1
(43) Pub. Date: Nov. 12, 2015

(54) Data Driver And A Display Apparatus Including The Same

(71) Applicant: Choong Sik RYU, Anyang-si (KR)

(72) Inventor: Choong Sik RYU, Anyang-si (KR)

(73) Assignee: Dongbu HiTek Co., Ltd., Bucheon-si (KR)

(21) Appl. No.: 14/629,081

(22) Filed: Feb. 23, 2015

(30) Foreign Application Priority Data
May 7, 2014 (KR) 10-2014-0053953

(51) Int. Cl. G09G 5/18; G09G 3/36

(52) U.S. Cl. CPC G09G 5/18; G09G 3/3696

(57) ABSTRACT

A data driver includes a random delay unit configured to receive and delay a first control signal and to generate a random delay signal based on the delay, a latch unit configured to store data in response to the random delay signal, a digital-analog conversion unit configured to convert the data from the latch unit into an analog signal, and an output unit configured to amplify and output the analog signal, wherein the time delay between the first control signal and the random delay signal is random.

This application claims priority from and the benefit of Korean Patent Application No. 10-2014-0053953, filed on May 7, 2014, which is hereby incorporated by reference for all purposes as if fully set forth herein.

### BACKGROUND OF THE DISCLOSURE

1. Field of the Disclosure

Exemplary embodiments of the disclosure relate to a data driver and a display apparatus including the same.

2. Discussion of the Background

When output amps of a data driver provide data voltages to data lines connected to a liquid crystal display or panel, EMI (Electro-Magnetic Interference) may arise between the data lines. Such EMI may be generated by frequency elements (e.g., clock or timing signals) that may control the data voltages provided to the data lines.

A timing controller sets a predetermined time difference in the control and/or timing signals provided to the data drivers, such that the frequency elements for the data voltages can be dispersed. However, this method has a disadvantage in that finding a time difference capable of reducing the EMI while at the same time providing adequate control and timing of the data drivers may be required by continuous adjustment of the timing controller.

### SUMMARY OF THE DISCLOSURE

Exemplary embodiments of the present disclosure provide a data driver which may reduce EMI (e.g., by controlling timing and/or frequency of certain signals in or to the data driver), and a display apparatus including the same.

Exemplary embodiments of the present disclosure relate to a data driver including a random delay unit configured to receive a first control signal, delay the first control signal by a random amount of time, and generate a random delay signal (e.g., based on the delayed first control signal); a latch unit configured to store data in response to the random delay signal; a digital-analog conversion unit configured to convert the data in the latch unit into an analog signal; and an output unit configured to amplify the analog signal.

The random amount of time may change randomly and/or periodically.

The random amount of time may change randomly based on a horizontal line signal or a frame signal.

The random amount of time may change randomly every horizontal line period or every frame period.

The random delay unit may include a random data signal generator configured to generate random data signals with a random value; and a delay circuit configured to delay the first control signal based on the random data signals and generate the random delay signal based on the delay (e.g., of the delay circuit).

The random data signal generator may include first through nth flip-flops in sequence; a logic calculator configured to perform a logic function on outputs from two or more of the first through nth flip-flops and provide a logic value (e.g., from the logic function) to the first flip-flop. The output of a former end flip-flop may be provided as an input of the next end flip-flop, and the outputs of the first through nth flip-flops may be data signals.

The logic calculator may comprise an exclusive-OR gate and may perform an XOR function on outputs from the (n−1)th flip-flop and the nth flip-flop.

The first through nth flip-flops may receive the horizontal line signal and the frame signal as timing and/or control signals.

The delay circuit may include an inverter configured to invert the first control signal and output an inverted first control signal, and the inverter may comprise a P-type transistor and an N-type transistor. The delay circuit may further include a first delay element connected between a first power rail and the inverter (e.g., a source of the P-type transistor), configured to delay a first transition (e.g., a rising time) of the inverted first control signal based on the random data signals.

The first delay element may include a plurality of first delay transistors connected between the first power rail and the inverter (e.g., the source of the P-type transistor) in parallel, and the first delay transistors are turned on or off based on the random data signals.

The data driver may further include a second delay element connected between a second power rail and the inverter (e.g., a source of the N-type transistor), to delay a second transition (e.g., a descending time) of the inverted first control signal based on the random data signals.

The second delay element may include a plurality of second delay transistors connected between the second power rail and the inverter (e.g., a source of the N-type transistor) in parallel, and the second delay transistors are turned on or off based on the random data signals.

The data driver may further include a level shifter configured to shift a voltage level of the data in the latch unit and to provide level shifted data to the digital-analog conversion unit.

Exemplary embodiments of the present disclosure also provide a display apparatus including a display panel comprising gate lines and data lines in rows and columns, the gate lines and the data lines crossing each other and forming a matrix, a pixel connected to each crossed gate line and data line, and a data driver unit including a plurality of data drivers configured to drive the data lines; and a timing controller configured to provide a first control signal to each of the data drivers, wherein each of the data drivers includes a random delay unit configured to receive and delay the first control signal and generate a random delay signal (e.g., based on the delay); a latch unit configured to store data (e.g., in response to the random delay signal); a digital-analog conversion unit configured to convert the data in the latch unit into an analog signal; and an output unit configured to amplify the analog signal. The delay between the first control signal and the random delay signal may be random.

The delay between the first control signal and the random delay signal may change randomly and/or periodically in each of the data drivers.

The delay between the first control signal and the random delay signal may change randomly every horizontal line period or frame period.

The delay between the first control signal and the random delay signal may change randomly based on a horizontal line signal or a frame signal in each of the data drivers.

An output timing of the output unit may change randomly every horizontal line period or frame period in each of the data drivers.

The random delay unit may include a random data signal generator configured to generate random data signals with a random value; and a delay circuit configured to delay the first control signal based on the random data signals and generate the random delay signal (e.g., based on the delay).

The delay circuit may include an inverter configured to invert the first control signal and output the inverted first control signal, and the inverter may comprise a P-type transistor and an N-type transistor. The delay circuit may further include a first delay element connected between a first power rail and the inverter (e.g., a source of the P-type transistor), to delay a transition (e.g., rising time) of the inverted first control signal (e.g., based on the random data signals).

According to embodiments of the disclosure, even without the control of the timing controller, the output timing of the data drivers may change randomly every horizontal line period or frame period, and the EMI may be reduced.

### BRIEF DESCRIPTION OF THE DRAWINGS

The accompanying drawings, which are included to provide a further understanding of the disclosed subject matter and are incorporated in and constitute a part of this specification, illustrate exemplary embodiments of the disclosed subject matter, and together with the description serve to explain the principles of the disclosed subject matter.

FIG. 1 is a block diagram of a data driver according to exemplary embodiments of the present disclosure;

FIG. 2 is a diagram illustrating one embodiment of the data driver shown in FIG. 1;

FIG. 3 is a diagram illustrating one embodiment of a random delay unit shown in FIG. 2;

FIG. 4 is a diagram illustrating one embodiment of a random data signal generator shown in FIG. 3;

FIG. 5 is a diagram illustrating one embodiment of a delay circuit shown in FIG. 3;

FIG. 6 is a diagram illustrating one embodiment of a first delay cell shown in FIG. 5;

FIG. 7 is a diagram illustrating one embodiment of a selection unit shown in FIG. 1;

FIG. 8 is a diagram illustrating a display apparatus including the data driver according to embodiments of the disclosure;

FIG. 9 is a diagram illustrating exemplary data drivers and data lines connected to the exemplary data drivers;

FIG. 10A is a diagram illustrating a timing chart of exemplary outputs from a first control signal of the exemplary data drivers and an exemplary output unit;

FIG. 10B is a diagram illustrating a timing chart of exemplary outputs from the exemplary random delay signal of the data drivers and from an exemplary output unit according to another embodiment;

FIG. 11A is a diagram illustrating the size of EMI generated in a frequency range between output units in a conventional display apparatus; and

FIG. 11B is a diagram illustrating the size of EMI generated in a frequency range between output units in an exemplary display apparatus 200 according to an embodiment.

### DETAILED DESCRIPTION OF THE ILLUSTRATED EMBODIMENTS

Exemplary embodiments of the disclosed subject matter are described more fully hereinafter with reference to the accompanying drawings. The disclosed subject matter may, however, be embodied in many different forms and should not be construed as limited to the exemplary embodiments set forth herein. Rather, the exemplary embodiments are provided so that this disclosure is thorough and complete, and will convey the scope of the disclosed subject matter to those skilled in the art. In the drawings, the size and relative sizes of layers and regions may be exaggerated for clarity. Like reference numerals in the drawings denote like elements. It will be understood that when an element or layer is referred to as being “on”, “connected to”, or “coupled to” another element or layer, it can be directly on, connected, or coupled to the other element or layer, or intervening elements or layers may be present. In contrast, when an element is referred to as being “directly on”, “directly connected to”, or “directly coupled to” another element or layer, there are no intervening elements or layers present.

Exemplary embodiments of the disclosed subject matter are described herein with reference to cross-sectional illustrations that may be schematic illustrations of idealized embodiments (and/or intermediate structures) of the disclosed subject matter. As such, variations from the shapes of the illustrations as a result, for example, of manufacturing techniques and/or tolerances are to be expected. Thus, exemplary embodiments of the disclosed subject matter should not be construed as limited to the particular shapes or regions illustrated herein, but are to include deviations in shapes that result, for example, from manufacturing. Unless otherwise defined, all terms (including technical and scientific terms) used herein have the same meaning as commonly understood by one of ordinary skill in the art to which this disclosed subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

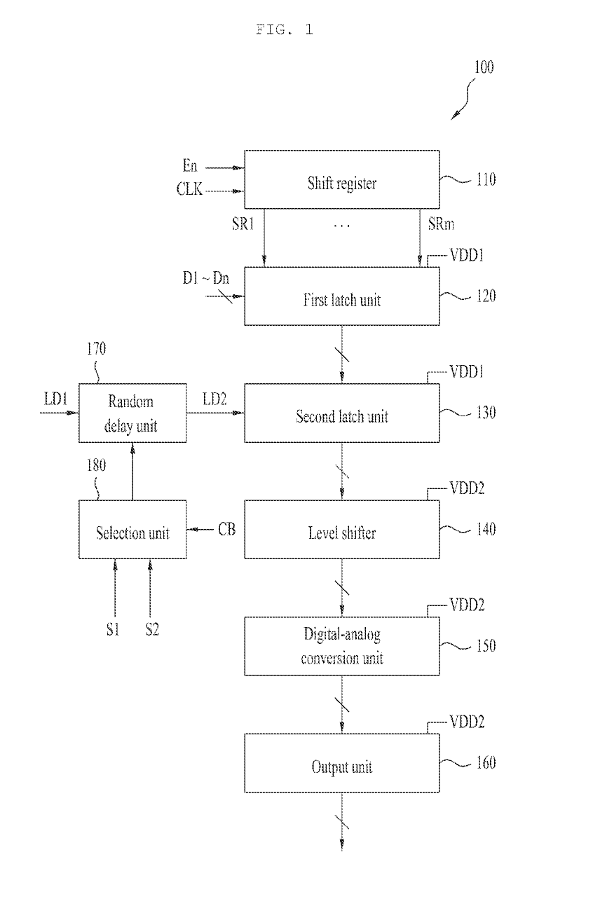

FIG. 1 is a block diagram of a data driver 100 according to exemplary embodiments of the present disclosure.

Referring to FIG. 1, the data driver 100 includes a shift register 110, a first latch unit 120, a second latch unit 130, a level shifter 140, a digital-analog conversion unit (e.g., a digital-analog converter) 150, an output unit 160, a random delay unit 170 and a selection unit (e.g., a multiplexer) 180.

The shift register 110 generates a shift signal (SR1 through SRm, where m is a natural number >1) in response to an enable signal (En) and a clock signal (CLK) to control timing in which data (e.g., digital video data) is sequentially stored in the first latch unit 120. A latch unit as used herein may also include a plurality of (e.g., n) latches or flip-flops in parallel or in series, a register, a bank or array of registers, etc.

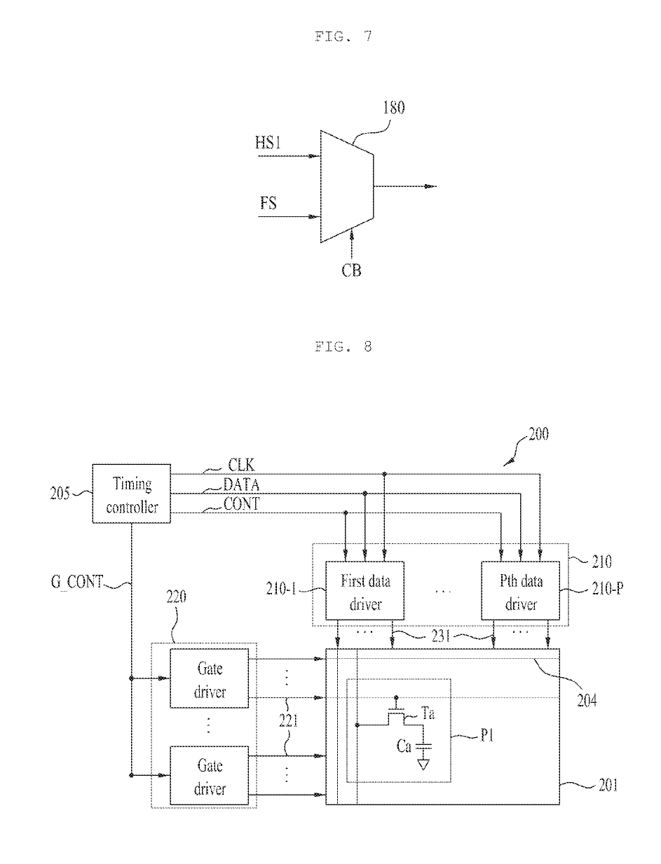

For instance, the shift register 110 receives a horizontal start signal from a timing controller (e.g., timing controller 205, see FIG. 8), shifts the received horizontal start signal in response to the clock signal (CLK), and outputs shift signals (SR1 through SRm, where m is a natural number >1). The horizontal start signal may be used together with a Start Pulse.

The first latch unit 120 stores data (D1˜Dn, where n is a natural number >1) therein, in response to the shift signals (SR1 through SRm, where m is a natural number >1) from the shift register 110. The data may represent pixels of components thereof to be displayed on a display element.

The first latch unit 120 may include a plurality of latches (not shown), and the latches may store the data (D1˜Dn, where n is a natural number >1) therein.

For instance, the data may be or comprise R (Red, G (Green) and B (Blue) data, and first latches of the first latch unit 120 may store R, G and B data therein.

In response to the shift signals (SR1 through SRm, where m is a natural number >1), the data (SR1 through SRm, where m is a natural number >1) received from the timing controller 205 may be sequentially stored in the first latches (LT1_1 through LT1_{—}n, where n is a natural number >1) provided in the first latch unit 120.

The second latch unit 130 stores the data output from the first latch unit 120, in response to a random delay signal (LD2). For instance, the second latch unit 130 may store the data output from the first latch unit 120 during a horizontal line period.

For instance, the horizontal line period may be the period required to completely store data corresponding to one horizontal line (see, e.g., line 204, FIG. 8) of a display panel (see, e.g., panel 201, FIG. 8) in the first latches (e.g., LT1_1 through LT1_{—}n, where n is a natural number >1) of the first latch unit 130.

For instance, the horizontal line period may be a period between a first time point and a second time point.

The first time point may be the time point when the data transmitted to the second latch unit 130 is output as a first analog signal by the digital-analog conversion unit 150 (i.e., after the data in the first latch unit 120 is transmitted to the second latch unit 130 in response to the horizontal line signal [e.g., HS1]). The second time point may be the time at which the data in the second latch unit 130 is output as a second analog signal by the digital-analog conversion unit 150 in response to a horizontal line signal of the next period.

For instance, the horizontal line period may mean one period of the horizontal line signal (e.g., HS1).

The second latch unit 130 may include a plurality of latches, and the number of the second latches may be equal to the number of the first latches.

The level shifter 140 shifts a voltage level of the data from the second latch unit 130. For instance, the level shifter 140 may shift a voltage of the data from the second latch unit 130 from a first voltage level (e.g., 1.8V or 2.5V) to a second voltage level (e.g., 3.3V).

Specifically, a driving voltage (VDD2) of the level shifter 140 may be higher than each driving voltage (VDD1) of the first latch unit 120 and the second latch unit 130.

For instance, the level shifter 140 may comprise a level shifter unit including a plurality of level shifters, and the number of the level shifters may be equal to the number of the first latches and/or the number of the second latches.

The digital-analog conversion unit 150 may convert the output of the level shifter 140 from digital data into an analog signal.

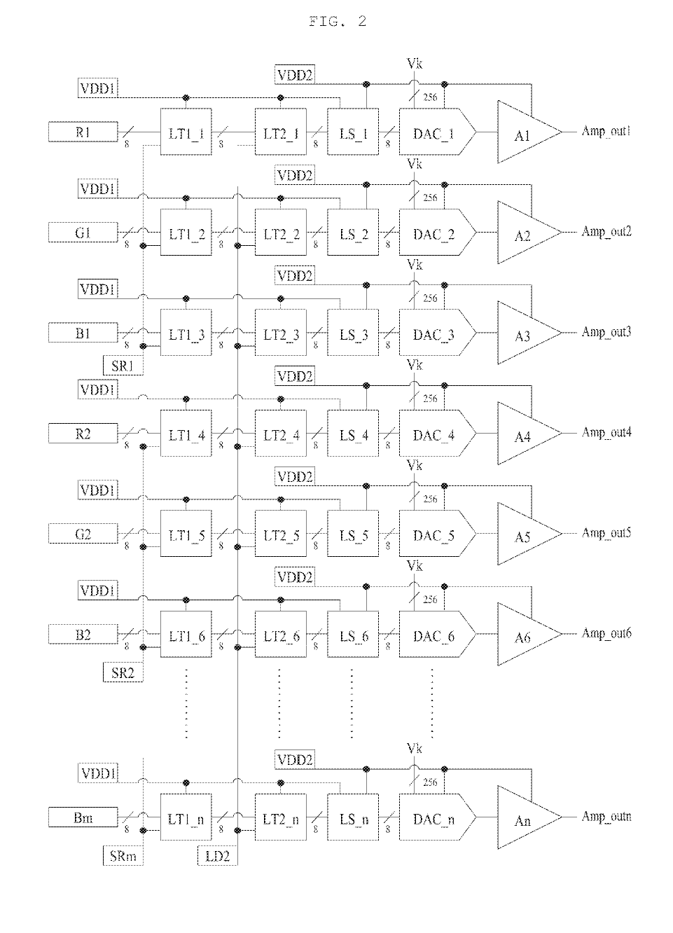

For instance, the digital-analog conversion unit 150 receives a plurality of grayscale voltages (e.g., Vk; see FIG. 2) from a power supply unit (not shown) and converts the output from the level shifter 140 into an analog signal, using the grayscale voltages.

For instance, the power supply unit (not shown) may comprise a plurality of resistances serially connected between a supply voltage source (VDD2) and a ground voltage source (GND), and it may generate grayscale voltages (Vk) divided into a plurality of steps (e.g., 2^{x} steps, where x is a natural number >2, such as 64, 128, 256 or more steps).

The output unit 1160 amplifies and/or buffers the analog signal from the digital-analog conversion unit 150 and outputs the amplified and/or buffered analog signal.

The random delay unit 170 receives a first control signal (LD1) from the timing controller 205 and delays the first control signal (LD1). The random delay unit 170 outputs a delayed first control signal (LD2, hereinafter, “random delay signal”) in response to a selection signal (S1 or S2) from the selection unit 180.

The first control signal (LD1) may be the control signal provided by the timing controller (e.g., timing controller 205, see FIG. 8) to transmit the data stored in the first latch unit 120 to the second latch unit 130 simultaneously.

The random delay unit 170 may change the delay period of the first control signal (LD1) by one horizontal line period or one frame period randomly.

In this instance, one horizontal line period is as mentioned above, and one frame period may mean the period required for the data driver to completely provide a frame's worth of (e.g., all) horizontal lines of a display panel (e.g., display panel 201, see FIG. 8) with data, or to complete data driving.

The selection unit 180 may determine the time point for the random delay time of the random delay unit 170.

For instance, the selection unit 180 may provide the random delay unit 170 with one or more selection signals (e.g., a first selection signal [S1] or a second selection signal [S2]), in response to a selection control signal (e.g., CB) from the timing controller 205.

The first selection signal (S1) may a signal for randomly changing the delay time of the random delay unit 170 every horizontal line period, and the second selection signal (S2) may be a signal for randomly changing the delay time of the random delay unit 170 every frame period.

FIG. 2 illustrates one embodiment of the data driver 100 shown in FIG. 1.

The same references as in FIG. 1 refer to the same elements, and the same elements and/or configuration(s) in both FIGS. 1 and 2 will be described briefly or omitted.

Referring to FIG. 2, the first latch unit 120 may include a plurality of latches (e.g., LT1_1 through LT_{—}n, where n is a natural number). The plurality of the first latches (e.g., LT1_1 through LT_{—}n, where n is a natural number >1) may be divided into a plurality of groups.

Each of the groups may include at least one first latch. When two or more first latches are in each of the groups, the first latches in each group do not overlap with each other.

For instance, red pixel (e.g., R) data may be stored in the first latch in each of the groups in the first latch unit, green pixel (e.g., G) data may be stored in the second latch in each of the groups in the first latch unit, and blue pixel (e.g., B) data may be stored in the third latch in each of the groups in the first latch unit. Each of the R, G and B data may include Q bits (where Q is a natural number >1 [e.g., Q=8]).

The first latch unit 120 may store data (e.g., D1˜Dn, where n is a natural number >1) in response to shift signals (e.g., SR1 through SRm, where m is a natural number >1).

For instance, the shift signals (e.g., SR1 through SRm, where m is a natural number >1) may be provided to the first latches in each of the groups simultaneously. Data (e.g., R1, G1 and B1) may be stored in the first latches (e.g., LT1_1 through LT1_3) in each of the groups in response to the shift signal (e.g., SR1).

The second latch unit 130 may include a plurality of second latches (e.g., LT2_1 through LT2_{—}n, where n is a natural number >1) corresponding to the first latches (e.g., LT1_1 through LT1_{—}n, where n is a natural number >1).

The plurality of the second latches (e.g., LT2_1 through LT2_{—}n, where n is a natural number >1) may store the data from corresponding ones of the first latches (e.g., LT1_1 through LT1_{—}n, where n is a natural number >1) in response to the random delay signal (e.g., LD2).

For instance, in response to the random delay signal (e.g., LD2), the data in the first latches (e.g., LT1_1 through LT1_{—}n, where n is a natural number >1) may be transferred and/or stored in the second lathes (e.g., LT2_1 through LT2_{—}n, where n is a natural number >1) at the same time.

The level shifter 140 may comprise a level shifter unit that includes a plurality of level shifters (e.g., LS_1 trough L_{—}n, where n is a natural number >1).

Each of the level shifters (e.g., LS_1 trough L_{—}n, where n is a natural number >1) may correspond to one of the second latches (e.g., LT2_1 through LT2_{—}n, where n is a natural number >1).

Each of the level shifters (e.g., LS_1 trough L_{—}n, where n is a natural number >1) shifts a voltage level of the data from the second latches (e.g., LT2_1 through LT2_{—}n, where n is a natural number >1) and outputs data with a shifted (e.g., increased) voltage level.

The digital-analog conversion unit 150 may include a plurality of digital-analog converters (e.g., DAC_1 through DAC_{—}n, where n is a natural number >1).

Each of the digital-analog converters (e.g., DAC_1 through DAC_{—}n, where n is a natural number >1) may convert an output of a corresponding one of the level shifters (e.g., LS_1 trough L_{—}n, 1<n which is a natural number >1).

The output unit 160 may include a plurality of amplifiers (e.g., A1 through An, where n is a natural number >1) and/or a plurality of buffers.

Each of the amplifiers (e.g., A1 through An) may amplify or buffer the analog signal output from a corresponding one of the digital-analog converters (e.g., DAC1 through DACn, where n is a natural number >1).

The random delay unit 170 may delay a first control signal (e.g., LD1) and output a random delay signal (e.g., LD2) according to the delay.

A time delay (or difference) between the first control signal (e.g., LD1) and the random delay signal (e.g., LD2) may be random. Also, a time difference or delay time between the first control signal (e.g., LD1) and the random delay signal (e.g., LD2) may be have a random value.

A time point when the delay time between the first control signal (e.g., LD1) and the random delay signal (e.g., LD2) changes randomly may be periodic. For instance, the delay time between the first control signal (e.g., LD1) and the random delay signal (e.g., LD2) may change randomly every horizontal line period or every frame period.

FIG. 3 is a diagram illustrating one embodiment of the random delay unit 170 shown in FIG. 2.

Referring to FIG. 3, the random delay unit 170 may include a random data signal generator 310 for generating random data signals (e.g., Q1 through Qn, where n is a natural number >1) and a delay circuit 320 for outputting the random delay signal (e.g., LD2).

The random data signal generator 320 generates random data signals (e.g., Q1 through Qn, where n is a natural number >1) having a random value.

For instance, the random data signal generator 320 may generate random data signals (e.g., Q1 through Qn, where n is a natural number >1) in response to a selection signal (e.g., S1 or S2) from the selection unit 180.

For instance, a first selection signal (e.g., S1) may be a first control signal (e.g., HS1; see FIG. 7) and a second selection signal (e.g., S2) may be a second control signal (e.g., FS, see FIG. 7).

The first control signal (e.g., S1) may be a horizontal line signal (e.g., HS1).

The horizontal line signal (e.g., HS1) may be a signal for starting horizontal line data output.

The second control signal (e.g., S2) may be a frame signal (e.g., FS).

The frame signal (e.g., FS) may be a signal having one frame period or a signal meaning an end of the one frame.

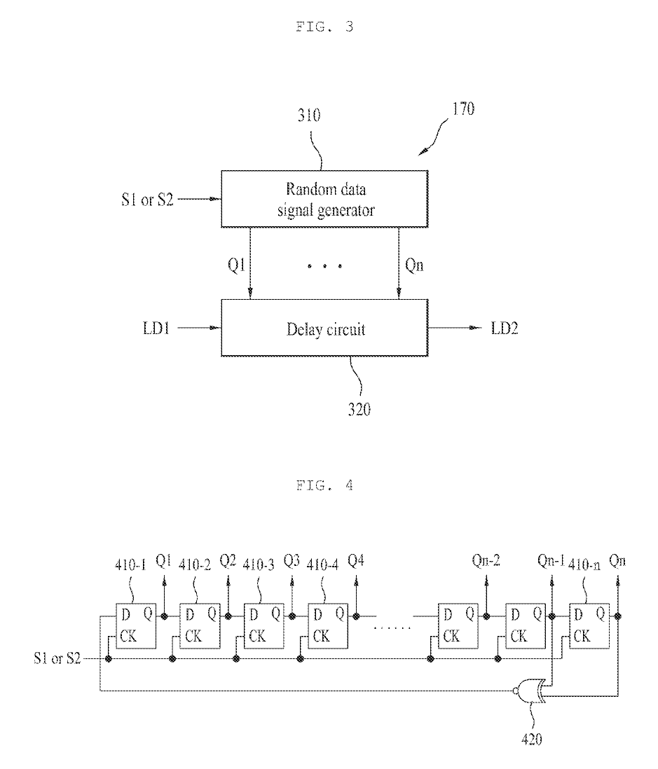

FIG. 4 is a diagram illustrating one embodiment of the random data signal generator 310 shown in FIG. 3.

Referring to FIG. 4, the random data signal generator 310 may include a plurality of flip-flops 410-1 through 410-n (where n is a natural number >1) and a logic gate 420.

The flip-flops (e.g., 410-1 through 410-n, where n is a natural number >1) may include a first flip-flop 410-1 through an nth flip-flop 410-n (where n is a natural number >1) in sequence. The output of one flip-flop (e.g., 410-1, 410-2, . . . 410-[n−1]) may be the input to the next flip-flop (e.g., 410-2, 410-3, . . . 410-n, respectively).

Each of the first through n flip-flops (e.g., 410-1 through 410-n, where n is a natural number >1) may be a D flip-flop (e.g., a data flip-flop or a delay flip-flop), but embodiments of the present disclosure are not limited thereto.

Each of the flip-flops (e.g., 410-1 through 410-n, where n is a natural number >1) may operate or store data in response to the selection signal (e.g., S1 or S2), which is received at the clock input of each flip-flop 410-1 through 410-n.

An output (e.g., the data output Qn−1) of the (n−1)th flip-flop 410-(n−1) may be an input (e.g., a data input) to the nth flip-flop 410-n. The output of the logic gate 420 may be provided as an input (e.g., a data input) to the first flip-flop (e.g., 410-1).

The logic gate 420 performs a logic function on the outputs of two or more flip-flops selected from the first through nth flip-flops (e.g., 410-1 through 410-n, where n is a natural number >1) and provides a value from the logic function to the input of the first flip-flop 410-1.

For instance, the logic gate 420 may be an exclusive OR (XOR) gate that performs a logic function (e.g., an XOR function) on the outputs of the (n−1)th flip-flop and the nth flip-flop. Then, it provides the result of the logic function as an input of the first flip-flop (e.g., 410-1).

A logic threshold possessed by each of the first through nth flip-flops (e.g., 410 through 410-n, where n is a natural number >1) may be set as one-half of an operation power.

For instance, the logic threshold may be defined as the minimum voltage of an input for making the output of the flip-flops (e.g., 410-1 through 410-n, where n is a natural number >1) be a high level and the maximum voltage of the input for outputting a low level.

The logic threshold of the flip-flops (e.g., 410-1 through 410-n, where n is a natural number >1) may be set as one-half of the voltage of the operation power (e.g., VCC/2). Accordingly, when the operation power (e.g., VCC) is applied to the flip-flops (e.g., 410-1 through 410-n, where n is a natural number >1), the flip-flops (e.g., 410-1 through 410-n, where n is a natural number >1) may have a random initial value. The flip-flops (e.g., 410-1 through 410-n, where n is a natural number >1) may not be reset at the time that the operation power is applied.

At the time that the operation power is applied, each of the first to nth flip-flops (e.g., 410-1 through 410-n, where n is a natural number >1) may have a random initial value and provide the output of the logic gate 420 as the input of the first flip-flop 410-1, such that the outputs (e.g., Q1 through Qn, where n is a natural number >1) of the first through nth flip-flops 410-1 through 410-n, (where n is a natural number >1) can have a random value stochastically.

The first through nth flip-flops (e.g., 410-1 through 410-n, where n is a natural number >1) are clocked by the selection signal (e.g., S1 or S2) such that the outputs (e.g., Q1 through Qn, where n is a natural number >1) of the first through nth flip-flops (e.g., 410-1 through 410-n, where n is a natural number >1) may change randomly every horizontal line period or frame period.

Accordingly, values of the random data signals (e.g., Q1 through Qn, where n is a natural number >1) have random initial values and the values can change randomly every horizontal line period or frame period.

Referring back to FIG. 3, the delay circuit 320 may delay the first control signal (e.g., LD1) based on the random data signals (e.g., Q1 through Qn, where n is a natural number >1) and generate a random delay signal (e.g., LD2) based on the delay. The delay time of the first control signal (e.g., LD1) and/or the delay circuit 320 may be determined by the random data signals (e.g., Q1 through Qn, where n is a natural number >1).

Values of the random data signals (e.g., Q1 through Qn, where n is a natural number) are random, and change every horizontal line period or frame period, such that the delay time of the first control signal (e.g., LD1) may change every horizontal line period or frame period, and remain random.

FIG. 5 is a diagram illustrating one embodiment of the delay circuit 320 shown in FIG. 3.

Referring to FIG. 5, the delay circuit 320 may include at least one delay cell (e.g., 510-1 through 510-R, where R is a natural number ≧1) in sequence.

At least one delay cell (e.g., 510-1 through 510-R, where R is a natural number ≧1) may delay the input signal based on the random data signals (e.g., Q1 through Qn, where n is a natural number >1) and output the delayed signal.

For instance, a plurality of delay cells may be provided. The first control signal (e.g., LD1) may be provided to an input end of the first delay cell 510-1 out of the sequential delay cells and delayed for a preset time period by each delay cell. The output of the last delay cell 510-R may be a random delay signal (e.g., LD2).

The time delay of the delay cells (e.g., 510-1 through 510-R, where R is a natural number ≧1) may be determined based on the random data signals (e.g., Q1 through Qn, where n is a natural number >1). For instance, the time delay of one or more of the delay cells (e.g., 510-1 through 510-R, where R is a natural number ≧1) may differ from the time delay of the other/remaining delay cells.

Each of the delay cells (e.g., 510-1 through 510-R, where R is a natural number ≧1) may be realized by an inverter or a buffer, but embodiments of the present disclosure are not limited thereto.

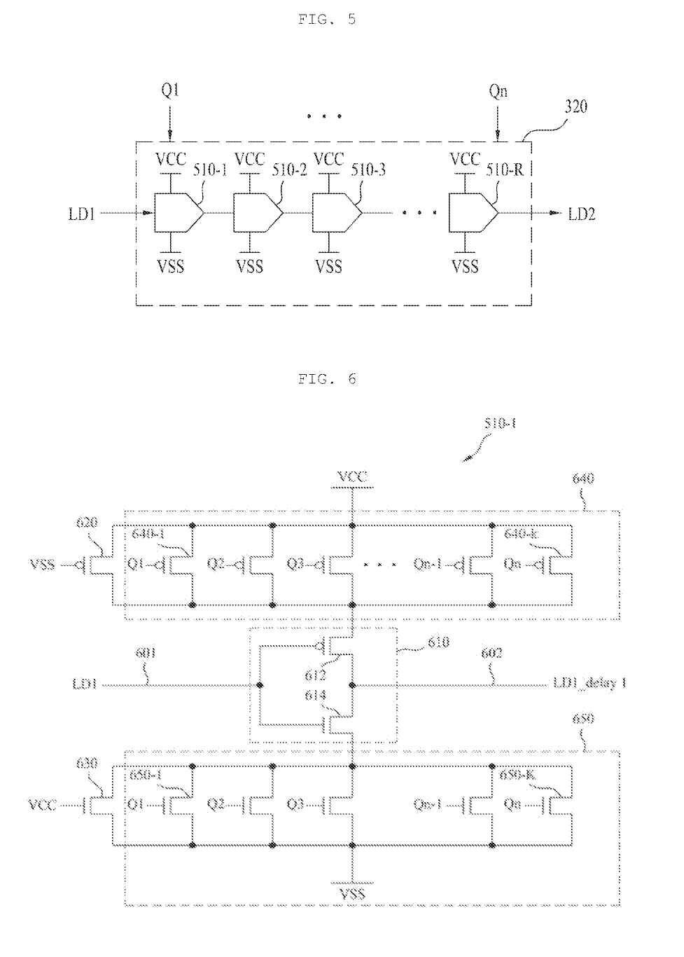

FIG. 6 is a diagram illustrating one embodiment of the first delay cell 510-1 shown in FIG. 5.

Referring to FIG. 6, the first delay cell 510-1 may include an inverter 610, a first switch 620, a second switch 630, a first delay element 640 and a second delay element 650. The structure of the other cells 510-2 through 510-R) may be the same or substantially the same as that of the first delay cell 510-1.

The inverter 610 may include a P-type transistor 612 and an N-type transistor 614. Also, the inverter 610 may have an input 601 that receives the first control signal (e.g., LD1) and an output 602 that outputs the first delay signal (e.g., LD1_delay1).

The inverter 610 may comprise or be a CMOS inverter having a PMOS transistor 612 and a NMOS transistor 614.

The first switch 620 may be between a source of the PMOS transistor 612 and a first power rail (e.g., VCC), and may receive a voltage from a second power rail (e.g., VSS) at a gate thereof. For instance, the first switch 620 may include a first source connected to or provided with the first power rail (e.g., VCC), a first drain connected to the source of the PMOS transistor 612, and a first gate receiving the second power rail (e.g., VSS).

The second switch 630 may be between a source of the NMOS transistor 614 and the second power rail (e.g., VSS), and may receive a voltage from the first power rail (e.g., VCC) at a gate thereof. For instance, the second switch 630 may include a second drain connected to or provided with the second power rail (e.g., VSS), a second source connected to the source of the NMOS 614, and a second gate receiving the first power rail (e.g., VCC).

The second power rail (e.g., VSS) is provided to the first gate of the first switch 610, and the first power rail (e.g., VCC) is provided to the second gate of the second switch 620, such that the first control signal (e.g., LD1) input to the first delay cell (e.g., 510-1) may be inverted, and the first delay signal (e.g., LD1_delay1) may have a value based on the result of the inversion.

For instance, when the input signal of the inverter 610, for instance, the first control signal (e.g., LD1) is at a low logic level, the PMOS transistor 612 may be turned on and the NMOS transistor 614 may be turned off such that a level of the first delay signal (e.g., LD1_delay1) may be at a high logic level (e.g., VCC).

In contrast, when an input signal of the inverter 610, for instance, a first control signal (e.g., LD1) is at a high logic level, the PMOS transistor 612 may be turned off and the NMOS transistor 614 may be turned on such that the first delay signal (e.g., LD1_delay1) may be at a low logic level (e.g., VSS).

The first delay element 640 may be connected between the first power rail (e.g., VCC) and the source of the PMOS transistor 612.

The first delay element 640 may include a plurality of delay transistors (e.g., 640-1 through 640-k, where k is a natural number >1) connected in parallel between the first power rail (e.g., VCC) and the PMOS transistor 612.

When the input of the inverter 610 is at a low logic level, the first delay element 640 may delay a rising transition or rising time of the first delay signal (e.g., LD1_delay1) based on the random data signals (e.g., Q1 through Qn, where n is a natural number >1).

One of the random data signals (e.g., Q1 through Qn, where n is a natural number >1) may be input to a gate of a corresponding one of the first delay transistors (e.g., 640-1 through 640-k, where k is a natural number >1).

The first delay transistors (e.g., 640-1 through 640-k, where k is a natural number >1) may be turned on or off based on the random data signals (e.g., Q1 through Qn, where n is a natural number >1).

The number of the turned-on first delay transistors (e.g., 640-1 through 640-k, where k is a natural number >1) may be determined based on the random data signals (e.g., Q1 through Qn, where n is a natural number >1).

The rising time of the first delay signal (e.g., LD1_delay1) may increase in proportion to the number of the turned-on first delay transistors (e.g., 640-1 through 640-k, where k is a natural number >1).

The random data signals (e.g., Q1 through Qn, where n is a natural number >1) change every horizontal line period or frame period to another random value. Accordingly, the number of the turned-on first delay transistors (e.g., 640-1 through 640-k, where k is a natural number >1) may change randomly every horizontal line period or frame period.

As the number of the turned-on first delay transistors (e.g., 640-1 through 640-k, where k is a natural number >1) changes randomly every horizontal line period or frame period, the rising time of the first delay signal (e.g., LD1_delay1) enabled by the first delay element 640 may change randomly every horizontal line period or frame period.

The second delay element 650 may be connected between the second power rail (e.g., VSS) and the NMOS transistor 614.

The second delay element 650 may include a plurality of second delay transistors (e.g., 650-1 through 650-k, where k is a natural number >1) connected in parallel between the second power rail (e.g., VSS) and the source of the NMOS transistor 614.

When the input of the inverter is at a high logic level, the second delay element 650 may delay a falling transition or descending time of the first delay signal (e.g., LD1_delay1) based on the random data signals (e.g., Q1 through Qn, where n is a natural number >1).

One of the random data signals (e.g., Q1 through Qn, where n is a natural number >1) may be input to a gate of a corresponding one of the second delay transistors (e.g., 650-1 through 650-k, where k is a natural number >1).

The second delay transistors (e.g., 650-1 through 650-k, where k is a natural number >1) may be turned on or off based on the random data signals (e.g., Q1 through Qn, where n is a natural number >1).

The descending time of the first delay signal (e.g., LD1_delay1) may decrease in proportion to the number of the turned-on second delay transistors (e.g., 650-1 through 650-k, where k is a natural number >1).

The random data signals (e.g., Q1 through Qn, where n is a natural number >1) change every horizontal line period or frame period to another random value. Accordingly, the number of the turned-on second delay transistors (e.g., 650-1 through 650-k, where k is a natural number >1) may change randomly every horizontal line period or frame period.

As the number of the turned-on second delay transistors (e.g., 650-1 through 650-k, where k is a natural number >1) changes randomly every horizontal line period or frame period, the descending time of the first delay signal (e.g., LD1_delay1) enabled by the second delay element 650 may changes randomly every horizontal line period or frame period.

In response to the selection control signal (e.g., CB) from the timing controller 205, the selection unit 180 may provide the random data signal generator 310 with a first selection signal (e.g., S1) or a second selection signal (e.g., S2).

FIG. 7 is a diagram illustrating one embodiment of the selection unit 180 shown in FIG. 1.

Referring to FIG. 7, the selection unit 180 may comprise or be a multiplexer. The selection unit 180 may output one of the first and second control signals (e.g., HS1 or FS) to the random data signal generator 310 in response to the selection control signal (e.g., CB).

FIG. 8 is a diagram illustrating an exemplary display apparatus 200 including the data driver according to embodiments of the disclosure.

Referring to FIG. 8, the display apparatus 200 includes a display panel 201, a timing controller 205, a data driver unit 210 and a gate driver unit 220.

The display panel 201 may include gate lines 221 in rows, data lines 231 in columns, and pixels (e.g., P1) in a matrix, connected to the gate lines and the data lines. Each pixel (e.g., P1) may include a transistor (e.g., T1) and a capacitor (e.g., Ca).

The timing controller 205 outputs a clock signal (e.g., CLK), data (e.g., DATA), and a data control signal (e.g., CONT) to each data driver in the data driver unit 210. The timing controller 205 also outputs a gate control signal (e.g., G_CONT) to each gate driver in the gate driver unit 220.

For instance, the data control signal (e.g., CONT) may include a horizontal start signal that is input to the shift resistor (e.g., shift resistor 110, see FIG. 1) of each data driver, an enable signal (e.g., En), a clock signal (e.g., CLK), a first control signal (e.g., LD1) that input to the random delay unit 170, a second control signal (e.g., CB) that is input to the selection unit 180, and a horizontal line signal (e.g., HS1) and a frame signal (e.g., FS).

The gate driver unit 220 may drive gate lines and may include a plurality of gate drivers. The gate driver unit 220 may output the gate control signal to control (e.g., turn on and/or off) the pixel transistors (e.g., Ta) connected to the gate lines.

The data driver unit 210 may drive the data lines and may include a plurality of data drivers (e.g., 210-1 through 210-P, where P is a natural number >1). Each of the data drivers (e.g., 210-1 through 210-P, where P is a natural number >1) may be as shown in FIGS. 1-7.

The timing controller 205 provides the first control signal (e.g., LD1) to each of the data drivers (e.g., 210-1 through 210-P, where P is a natural number >1).

The random data signals (e.g., Q1 through Qn, where n is a natural number >1) generated by the random data signal generator 310 in each of the data drivers (e.g., 210-1 through 210-P, where P is a natural number >1) may have a random value.

As values of the random data signals (e.g., Q1 through Qn, where n is a natural number >1) in each of the data drivers (e.g., 210-1 through 210-P, where P is a natural number >1) are random, the delay time of the random delay signals (e.g., LD2) in each of the data drivers (e.g., 210-1 through 210-P, where P is a natural number >1) may be random.

As the delay time of the random delay signals (e.g., LD2) in the data drivers (e.g., 210-1 through 210-P, where P is a natural number >1) are determined randomly, the time at which data is stored in the second latch unit 130 may be randomly determined in each data driver 210-1 through 210-P. Accordingly, the time when the output unit 160 in each data driver (e.g., 210-1 through 210-P, where P is a natural number >1) provides data to the data lines in the display 201 is also random.

For instance, the time at which the output unit 160 in each data driver (e.g., 210-1 through 210-P, where P is a natural number >1) provides the data line with data may be different from other output units.

The delay time of the random delay signal (e.g., LD2) in each of the data drivers (e.g., 210-1 through 210-P, where P is a natural number >1) may change every horizontal line period or frame period.

FIG. 9 is a diagram illustrating data drivers (e.g., 210-1 through 210-P, where P is a natural number >1) and data lines (e.g., 1-1 through P-n) connected to the data drivers.

Referring to FIG. 9, the data lines (e.g., 1-1˜1-n through P-1˜P-n) may be divided into first through P groups (e.g., 910-1 through 910-P). Each of the data drivers (e.g., 210-1 through 210-P, where P is a natural number >1) may provide data to the data lines in a corresponding one of the first through P groups (e.g., 910-1 through 910-P).

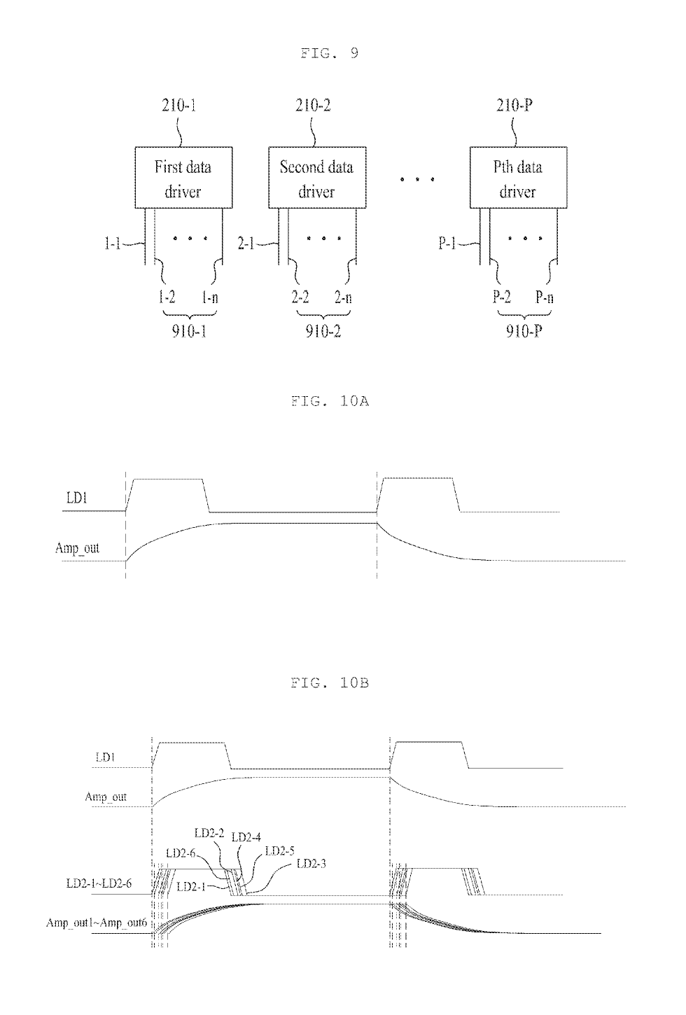

FIG. 10A is a timing chart illustrating a first control signal input into a data driver without the random delay unit and an output from an output unit in the data driver without the random delay unit.

Referring to FIG. 10A, there is little time difference between a rising transition of the first control signal (e.g., LD1) in the conventional data driver without the random delay unit and the output (e.g., Amp out) of an output unit in the conventional data driver, and there is little or no time difference between different outputs of the different output units in the conventional data driver.

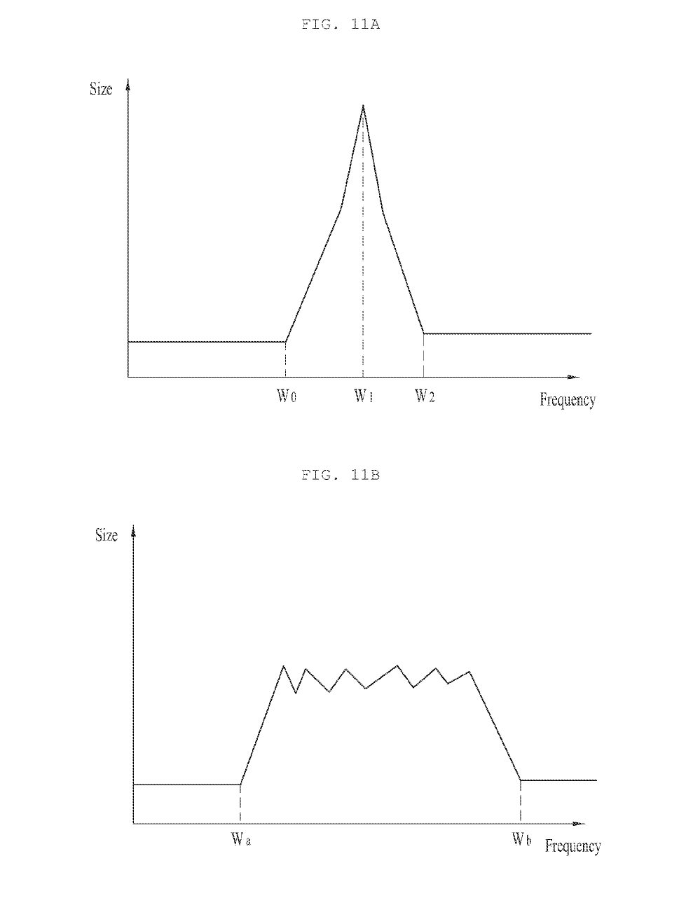

FIG. 11A is a diagram illustrating the size or amount of EMI generated in a particular frequency range from the outputs of the output units in a conventional data driver.

Referring to FIG. 11A, the size or amount of the EMI is large at a certain or preset frequency (e.g., W1) or in a narrow frequency band (e.g., W0˜W2).

FIG. 10B is a timing chart illustrating various random delay signals (e.g., LD2_1˜LD2_6) in exemplary data drivers representative of the present invention and corresponding output signals (e.g., Amp_out2˜Amp_out6; see FIG. 2) from output units 160 according to an embodiment.

FIG. 10B shows random delay signals (e.g., LD2_1 LD2_6) for each of six data lines and the corresponding outputs (e.g., Amp_out1˜Amp_out6) from the output unit 160. FIG. 10B may also be a timing chart of the data signals (e.g., Amp_out1˜Amp_out6) provided to corresponding data lines (e.g., 1-1, 2-1, 3-1, 4-1, 5-1 and 6-1) in each of six groups of data lines (e.g., as shown in FIG. 9).

Referring to FIG. 10B, the delay time between a first control signal (e.g., LD1) and a random delay signal in each of the data drivers (e.g., 210-1 through 210-P, where P is a natural number >1; P=6 in FIG. 10B) may have a random value. Accordingly, the random delay signals (e.g., LD2-1˜LD2-6) in the six data drivers have different delay times, and such delay time differences are random.

The output timing of the outputs from each of the data drivers (e.g., 210-1 through 210-P, where P is a natural number >1; P=6 in FIG. 10B) may be random, based on the random delay signals LD2-1˜LD2-6). The random delay signals LD2-1˜LD2-6 cause random time differences between the outputs Amp_out1˜Amp_out6 from the output units 160.

The output timing of the outputs from each of the data drivers (e.g., 210-1 through 210-P, where P is a natural number >1; P=6 in FIG. 10B) may change every horizontal line period or frame period.

FIG. 11B is a diagram illustrating the size or amount of EMI generated in a particular frequency range from the outputs of the output units in a data driver 100 according to an embodiment of the present invention.

Referring to FIG. 11B, the size or amount of the EMI caused by the outputs may be distributed over a relatively broad frequency band (e.g., Wa through Wb, where [Wb-Wa]>[W2-W1]). Compared with FIG. 11A, FIG. 11B shows that the maximum size or amount of the EMI at frequency W1 and frequencies adjacent to W1 is decreased relative to a similar or otherwise identical data driver that does not include a random delay unit (e.g., random delay unit 170 in FIGS. 1 and 3-6).

In one embodiment, a first control signal (e.g., LD1) is delayed and a random delay signal (e.g., LD2) is generated. Data is transmitted to a second latch unit 130 using the generated random delay signal (e.g., LD2). The delay time of the random delay signal (e.g., LD2) may be random with respect to the first control signal (e.g., LD1).

In one embodiment, the delay time of the random delay signal (e.g., LD2) is random, and prevents the EMI from increasing at a specific frequency, and also spreads the EMI across a relatively broad frequency band.

In one embodiment, the delay time of the random delay signal (e.g., LD2) changes randomly every horizontal line period or frame period. Even without the control of the timing controller, the output timing of the data driver may change randomly every horizontal line period or frame period, and the EMI characteristics caused by the frequency may be improved.

It will be apparent to those skilled in the art that various modifications and variations can be made in the present disclosure without departing from the spirit or scope of the disclosed subject matter. Thus, it is intended that the present disclosure cover the modifications and variations of the disclosed subject matter provided they come within the scope of the appended claims and their equivalents.

What is claimed is:

1. A data driver comprising:
a random delay unit configured to receive and delay a first control signal and generate a random delay signal;
a latch unit configured to store data in response to the random delay signal;
a digital-analog conversion unit configured to convert the data from the latch unit into an analog signal; and
an output unit configured to amplify and output the analog signal,
wherein a time delay between the first control signal and the random delay signal is random.

2. The data driver of claim 1, wherein the time delay between the first control signal and the random delay signal changes randomly and/or periodically.

3. The data driver of claim 1, wherein the time delay between the first control signal and the random delay signal changes in response to a horizontal line signal or a frame signal.

4. The data driver of claim 1, wherein the time delay between the first control signal and the random delay signal changes every horizontal line period or frame period.

5. The data driver of claim 3, wherein the random delay unit comprises:
a random data signal generator configured to generate random data signals with a random value; and
a delay circuit configured to delay the first control signal based on the random data signals.

6. The data driver of claim 5, wherein the random data signal generator comprises:
first through nth flip-flops in sequence;
logic configured to perform a logic function on outputs of two or more of the first through nth flip-flops and to provide a value from the logic function as an input to the first flip-flop.

7. The data driver of claim 6, wherein the logic comprises an exclusive-OR gate and performs a logic function on outputs of the (n−1)th flip-flop and the nth flip-flop.

8. The data driver of claim 6, wherein the first through nth flip-flops receive the horizontal line signal or the frame signal at a clock input thereof.

9. The data driver of claim 5, wherein the delay circuit comprises:
an inverter configured to invert the first control signal and to output an inverted first control signal; and
a first delay element connected between a first power rail and the inverter, configured to delay a first transition of the inverted first control signal based on the random data signals.

10. The data driver of claim 9, wherein the first delay element comprises:
a plurality of first delay transistors connected in parallel between the first power rail and the inverter, wherein the first delay transistors are turned on or off by the random data signals.

11. The data driver of claim 9, further comprising:
a second delay element connected between a second power rail and the inverter, configured to delay a second transition of the inverted first control signal based on the random data signals.

12. The data driver of claim 11, wherein the second delay element comprises:
a plurality of second delay transistors connected in parallel between the second power rail and the inverter, wherein the second delay transistors are turned on or off by the random data signals.

13. The data driver of claim 1, further comprising:
a level shifter configured to shift a voltage level of the data from the latch unit and to provide level shifted data to the digital-analog conversion unit.

14. A display apparatus comprising:
a display panel comprising gate lines in rows and data lines arranged in columns, the gate lines and the data lines crossing each other and forming a matrix, and a pixel connected to each crossed gate line and data line;
a data driver unit comprising a plurality of data drivers configured to drive the data lines; and
a timing controller configured to provide a first control signal to each of the data drivers,
wherein each of the data drivers comprises:
a random delay unit configured to receive and delay a first control signal and generate a random delay signal;
a latch unit configured to store data in response to the random delay signal;
a digital-analog conversion unit configured to convert the data from the latch unit into an analog signal; and
an output unit configured to amplify and output the analog signal,
wherein a time delay between the first control signal and the random delay signal is random.

15. The display apparatus of claim 14, wherein the time delay between the first control signal and the random delay signal changes randomly and/or periodically in each of the data drivers.

16. The display apparatus of claim 14, wherein the time delay between the first control signal and the random delay signal changes every horizontal line period or frame period.

17. The data driver of claim 14, wherein the time delay between the first control signal and the random delay signal changes in response to a horizontal line signal or a frame signal in each of the data drivers.

18. The data driver of claim 14, wherein the random delay unit comprises:
a random data signal generator configured to generate random data signals with a random value; and
a delay circuit configured to delay the first control signal based on the random data signals.

19. The data driver of claim 18, wherein the delay circuit comprises:
an inverter configured to invert the first control signal and to output an inverted first control signal;
a first delay element connected between a first power rail and the inverter, configured to delay a first transition of the inverted first control signal based on the random data signals; and
a second delay element connected between a second power rail and the inverter, configured to delay a second transition of the inverted first control signal based on the random data signals.

20. A method of driving data, comprising:
receiving and delaying a first control signal in a plurality of parallel data drivers to generate a plurality of random delay signals, wherein a time delay between the first control signal and the random delay signals is random;
storing data in a plurality of latch units in response to the random delay signals;
converting the data from the latch units into a plurality of analog signals; and
amplifying and outputting the plurality of analog signals.
